(19) United States
(12) Patent Application Publication
(10) Pub. No.: US 2019/0292308 A1
(43) Pub. Date: Sep. 26, 2019

(54) ANHYDRIDE EPOXY CURING AGENTS HAVING IMIDAZOLE SALT ADDITIVES FOR EPOXY RESIN SYSTEMS

(71) Applicants: Gauri Sankar Lal, Whitehall, PA (US); Edze Jan Tijsma, Zeist (NL); Marieke Theodora van Gorkom, De Moer (NL); EVONIK DEGUSSA GMBH, Essen (DE)

(72) Inventors: Gauri Sankar LAL, Whitehall, PA (US); Edze Jan TIJSMA, Zeist (NL); Marieke Theodora van GORKOM, De Moer (NL)

(73) Assignee: Evonik Degussa GmbH, Essen (DE)

(21) Appl. No.: 16/319,708

(22) PCT Filed: Aug. 14, 2017
(86) PCT No.: PCT/US2017/046681

§ 371 Date: Jan. 22, 2019

Related U.S. Application Data
(60) Provisional application No. 62/374,984, filed on Aug. 15, 2016.

(51) Int. Cl. C08G 59/50; C08G 59/68; C08G 59/42

(52) U.S. Cl. CPC C08G 59/5073; C08G 59/42; C08G 59/685

(57) ABSTRACT

A curing agent composition including at least one imidazole salt represented by the structure:

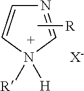

where R, R′, is H, or alkyl (1-20 carbon atoms) preferably lower alkyl of 1-7 carbon atoms, haloalkyl (1-20 carbon atoms), aryl, hydroxyl alkyl (1-7 carbon atoms), ester group(s), substituted alkyl and X⁻ is a carboxylate anion of 1-40 carbon atoms; and at least one anhydride curing agent. The disclosed imidazole salts when combined with the anhydride curing agent provide improved latency for epoxy systems while maintaining reactivity at elevated temperature. Epoxy compositions, cured epoxy products and methods for forming cured epoxy products are also disclosed.

### BACKGROUND OF THE INVENTION

The present disclosure is directed to a composition and method for making and utilizing epoxy curing agents for the production of cured epoxy products. In particular, the present disclosure is directed to imidazole salt additives providing improved latency to anhydride curing agents for epoxy resins while maintaining reactivity at high temperature.

Certain anhydrides are known for use as curing agents for epoxy resins. The commercially known anhydrides possess the advantage of producing only mild skin irritation compared to amine curing agents and generally provide acceptable viscosity, pot life and reactivity when mixed with epoxy resins. Epoxy resins cured with anhydrides generally exhibit high temperature stability, good radiation stability as well as useful physical and electrical properties above their glass transition temperature (Tg).

The reaction of anhydrides with epoxy resins is dependent upon a number of factors including, for example, cure time and temperature, post-cure and post-cure temperature, presence or absence of accelerators, type of accelerator, amount of hydroxyl groups in the resin, ratio of anhydride to epoxy and the amount of free acid in the system. Anhydrides will typically not react with epoxy groups in the absence of an accelerator.

Typical commercial epoxy-resin/anhydride formulations use anhydride accelerators. These are acidic or basic compounds. Acids favor etherification while bases favor esterification. The optimum anhydride/epoxy ratio and the cured properties of the resin are determined by the accelerator used. Tertiary amines and imidazoles are conventionally used as anhydride accelerators. These conventional amines are described in Three Bond Technical News vol. 32, Dec. 20, 1990. Conventional amines include benzlydimethylamine (BDMA) and tris(dimethylamino-methyl)phenol, triethylene diamine (TEDA), N,N′-dimethylpiperazine and 2-(dimethylaminomethyl)phenol. Conventional imidazoles are 1-methylimidazole, 2-ethyl-4-methylimidazole,1-cyanoethyl-2-undecylimidazolium trimellitate and the epoxy-imidazole adduct (1-methylimidazole/Epon 828).

U.S. Pat. No. 3,839,281 discloses using N-hydroxyethyl piperidines and piperazinyl compounds as accelerators for epoxy resins systems cured with anhydrides and dicyandiamide (DICY). U.S. Pat. No. 5,650,477 discloses quaternary ammonium salts bearing an ether linkage with a nitrile group were used as catalysts for anhydride cured expoxy resins under microwave irradiation. Solid metal acetylacetonates are described as latent curing agents in J. Appl. Poly. Sci, 26, 1981, 979 by J. Smith. These solid metal acetylacetonates have the disadvantage of not being able to be dispersed adequately to effect efficient curing of epoxy resins by anhydrides. U.S. Pat. No. 6,441,064 B1 describes an imidazole phosphate salt which was used to accelerate dicyandiamide (DICY), which is an amine-based latent epoxy resin curing agent. In U.S. Pat. No. 3,489,685, conventional imidazoles were used as co-curing agents with polyamines or anhydrides for curing epoxy resins,

The previously disclosed patents, patent applications and documents are hereby incorporated by reference.

There is a need in this art for epoxy curing agents with improved latency in order to minimize the waste in materials and labor of a mixed system thereby providing a significant saving in raw material cost along with good high temperature reactivity, in particular with low reactive epoxy resins, as well as cured epoxy systems having desirable physical properties.

### BRIEF SUMMARY OF THE INVENTION

Embodiments, according to the present disclosure, solve problems associated with conventional anhydride accelerators by providing imidazole salts that provide improved latency and rapid high temperature curing (e.g., curing for a period of about 2 hours at a temperature of about 110° C. to about 150° C.) of epoxy systems. The imidazole salt additives, according to the present disclosure, function as latent curing agents and enable prolonged storage stability in an admixture with anhydride curing agents and epoxy resins at ambient temperature as well as rapid curing when heated to an elevated cure temperature. In addition, the inventive imidazole salts may reduce cycle time and thereby provide increased throughput when producing cured epoxy resin components.

One aspect, according to the present disclosure, includes a curing agent composition including at least one imidazole salt represented by the structure:

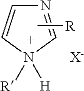

where R, R′ may be H, or alkyl (1-20 carbon atoms) preferably lower alkyl of 1-7 carbon atoms, haloalkyl (1-20 carbon atoms), aryl, hydroxyl alkyl (1-7 carbon atoms), ester group(s), substituted alkyl and X⁻ is a carboxylate anion of 1-40 carbon atoms; and at least one anhydride curing agent.

Another aspect, according to the present disclosure, includes an epoxy composition comprising a curing agent composition including at least one imidazole salt represented by the structure:

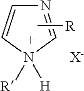

where R, R′ may be H, or alkyl (1-20 carbon atoms) preferably lower alkyl of 1-7 carbon atoms, haloalkyl (1-20 carbon atoms), aryl, hydroxyl alkyl (1-7 carbon atoms), ester group(s), substituted alkyl and X⁺ is a carboxylate anion of 1-40 carbon atoms; and at least one anhydride curing agent. The epoxy composition further includes at least one epoxy resin.

Another aspect, according to the present disclosure, includes a method of forming a cured epoxy product. The method includes providing an epoxy curing agent comprising at least one imidazole salt represented by the structure:

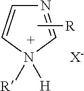

where R, R′ may be H, or alkyl (1-20 carbon atoms) preferably lower alkyl of 1-7 carbon atoms, haloalkyl (1-20 carbon atoms), aryl, hydroxyl alkyl (1-7 carbon atoms), ester group(s), substituted alkyl and X− is a carboxylate anion of 1-40 carbon atoms, and an anhydride curing agent. The epoxy curing agent is contacted with at least one epoxy resin. The composition is heated to a curing temperature to form a cured epoxy product.

A further aspect of the disclosure includes a composite wherein a composition comprising at least one imidazole salt, at least one anhydride curing agent and at least one epoxy resin embeds at least one filler material, such as fiberglass or quartz sand.

Another aspect of the disclosure includes a composition comprising at least one imidazole salt, at least one anhydride curing agent, at least one epoxy resin wherein the composition has an onset temperature of cure ranging from about 50 to about 200° C.; a ΔHc of about 150 to about 400 J/g, and a Tg ranging from about 40 to about 175° C.

Epoxy-resin cured with anhydrides and imidazole salts of the disclosure may be used in a wide range of applications including electrical insulating materials, molded articles, fiber reinforced composites, filled castings among other uses.

The various aspects of the invention can be used alone or in combination.

### DETAILED DESCRIPTION OF THE INVENTION

Embodiments of the present disclosure relate to carboxylic acid salts of imidazoles for use as an accelerator for anhydride based epoxy curing agents. The inventive carboxylic acid salts of certain imidazoles are latent anhydride accelerators and enable epoxy resin curing when heated to an elevated temperature (e.g., an onset temperature of greater than about 50° C.). The imidazole salts, according to the present disclosure, may be used to obtain an epoxy curing agent having an onset temperature ranging from about 50 to about 200° C., about 100 to about 180° C. and in some cases about 100 to about 150° C. The imidazole salts, according to the present disclosure, include a ΔHc>120 J/g (e.g., about 150 to about 400 J/g, about 200 to about 375 J/g and in some cases about 250 to about 350 J/g). The imidazole salts, according to the present disclosure, may be combined with an anhydride curing agent in order to obtain a cured epoxy resin system having a Tg ranging from about 40 to about 175° C., about 40 to about 150° C. and in some cases about 50 to about 125° C. In one aspect of the disclosure, epoxy curing agent includes an imidazole salt represented by the formula of Structure 1:

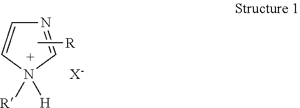

Compounds of Structure 1 may contain at least one and at most three substituents on the ring carbon atoms wherein R, R′ may be H, or alkyl (1-20 carbon atoms) preferably lower alkyl of 1-7 carbon atoms, haloalkyl (1-20 carbon atoms), aryl, hydroxyl alkyl (1-7 carbon atoms), ester group(s), substituted alkyl. X⁻ is a carboxylate anion of 1-40 carbon atoms. Examples of imidazole compounds that can be used to form the imidazole salt represented by Structure 1 comprise at least one member selected from the group consisting of 1-methylimidazole, 2-methylimidazole, 2-ethyl-4-methylimidazole, 2-imidazol-1-yl-succinic esters,1-cyanoethyl-2-undecylimidazolium trimellitate and the epoxy-imidazole adduct, and combinations thereof.

In one embodiment of the present disclosure, the imidazole salt, according to the present disclosure, is a contact product of a suitable imidazole compound with carboxylic acid. The term “contact product” is used herein to describe compositions wherein the components are contacted together in any order, in any manner, and for any suitable length of time. For example, the components may be contacted by blending or mixing. Further, contacting of any component may occur in the presence or absence of any other component of the compositions or formulations described herein. Combining additional catalyst components may be done by any method known to one of skill in the art. For example, in one aspect, according to the present disclosure, catalyst compositions may be prepared by combining imidazole salt, according to the present disclosure, with at least one carboxylic acid. This typically occurs in solution form.

Representative imidazole compounds that can be used to form the imidazole salt, according to the present disclosure, includes, but is not limited to, at least one member selected from the group consisting of 1-methylimidazole, 2-methylimidazole, 2-ethyl-4-methylimidazole,2-imidazol-1-yl-succinic esters, 1-cyanoethyl-2-undecylimidazolium trimellitate, the epoxy-imidazole adduct thereof, and combinations thereof. Representative carboxylic acid compound that can be used to form the imidazole salt, according to the present disclosure, includes, but is not limited to, at least one member selected from the group consisting of acetic acid, propanoic acid, hexanoic acid, 2-ethylhexanoic acid, octanoic acid, nonanoic acid, decanoic acid, tall oil fatty acid (TOFA), dimer acid, and mixtures thereof.

Imidazole salts, according to the present disclosure, may be formed by contacting the imidazole compound with at least one carboxylic acid compound. When using a carboxylic acid to form the inventive salt, the salt is formed from one mole equivalent of the imidazole with one mole equivalent of the acid, while with diicarboxylic acid the salt is formed from one mole equivalent of the imidazole with half a molar equivalent of the acid.

While any suitable method can be used for contacting at least one imidazole with at least one carboxylic acid, an exemplary method comprises contacting 1-methylimidazole with TOFA. The molar ratio of imidazole to carboxylic acid can range from about 0.5 to about 2.5, about 1.0 to about 2.0 and in some cases about 1.0 to about 1.5.

In an embodiment of the present disclosure, the imidazole salt, according to the present disclosure, is combined with a suitable anhydride curing agent in order to obtain an epoxy curing agent formulation. The imidazole salts and anhydride curing agent can be combined by any suitable method, such as mixing, pumping one into the other, vacuum transferring one into the other and under ambient or pressure conditions (e.g., a pressure of about 0.1 Torr to about 10 Torr). Examples of suitable anhydride curing agents include, but are not limited to, linear polymeric anhydrides, such as polysebacic and polyazelaic anhydride; alicyclic anhydrides, such as methyltetrahydrophthalic anhydride, tetrahydro phthalic anhydride, methyl nadic anhydride, hexahydro phthalicanhydride, and methylhexahydro phthalic anhydride; simple alicylic anhydrides, such as succinic anhydride, substituted succinic anhydride, citric acid anhydride, maleic anhydride and special adducts of maleic anhydride, dodecyl succinic anhydride, maleic anhydride vinyl and styrene copolymers of maleic anhydride, multi-ring alicyclic anhydrides and aromatic anhydride, such as phthalic anhydride and trimellitic anhydride. Examples of suitable anhydride accelerators also include dianhydrides, such as pyromellitic dianhydride (PMDA) and 3,3′, 4,4′-benzophenone-tetracarboxylicdianhydride (BTDA). The imidazole salt may combined with anhydride curing agent in a ratio of about 1 to about 40 parts per hundred parts of curing agent, about 1 to about 20 parts; and in some cases about 1 to about 10 parts. The epoxy curing agents, according to the present disclosure, may contain from about 0.8 to about 1.1 equivalents of anhydride curing agents per equivalent of epoxy, about 1.0 to about 1.0 and in some cases about 0.95 to about 1.05 equivalents.

In another aspect of the disclosure, the epoxy curing agent is substantially free of water. By “substantially free of water” it is meant that the curing agent comprises less than about 5 wt. %, less than 2 wt. % and in some cases less than 0.5 wt. % water.

In a further aspect of the disclosure, the epoxy curing agent may comprise, but is not limited to, at least one additive selected from the group consisting of glass beads, talc, calcium carbonate, carbon black, silica beads, clay, fibers, or mica. The amount of such additives can range from about 0.1% to about 60 wt %, about 10% to about 50% and in some cases from about 20% to about 40%.

The curing agent formulation, according to the present disclosure, may be used for curing an epoxy resin. By “curing” it is meant a reaction of the anhydride curing agent with the epoxy resin to produce a polymeric composition consisting of polyether groups and polyester groups. Examples of epoxy resins that may be cured with the inventive curing agent accelerator comprise at least one of the following: Epoxy resins commercially available under the trade name DER 331 (available from Dow) and EPON 828 (available from Hexion Specialty Chemicals) are suitable for this application. Other epoxy resins may include, but are not limited to, bi-functional epoxies, such as, bisphenol-A and bisphenol-F resins. Multifunctional epoxy resin, as utilized herein, describes compounds containing two or more 1,2-epoxy groups per molecule. Epoxide compounds of this type are well known to those of skill in the art and are described in Y. Tanaka, “Synthesis and Characteristics of Epoxides”, in C. A. May, ed., Epoxy Resins Chemistry and Technology (Marcel Dekker, 1988), which is incorporated herein by reference.

Another class of epoxy resins suitable for use in the instant disclosure comprises the products obtained from epoxidization of vegetable oils. These epoxidized vegetable oils, may include multifunctional epoxy resins, such as epoxidized soybean oil or epoxidized linseed oil. Epoxy resins commercially available under the trade name Vikoflex (available from Arkema) and Lankroflex (available from Akcros) are suitable for this application.

Another class of epoxy resins suitable for use in the system, according to the present disclosure, comprises the glycidyl ethers of polyhydric phenols, including the glycidyl ethers of dihydric phenols. Illustrative examples include, but are not limited to, the glycidyl ethers of resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane (commercially known as bisphenol A), bis-(4-hydroxyphenyl)-methane (commercially known as bisphenol-F, and which may contain varying amounts of 2-hydroxyphenyl isomers), and the like, or any combination thereof. Additionally, advanced dihydric phenols of the following structure also are useful in the present disclosure:

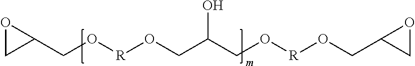

where m is an integer, and R is a divalent hydrocarbon radical of a dihydric phenol, such as those dihydric phenols listed above. Materials according to this formula can be prepared by polymerizing mixtures of a dihydric phenol and epichlorohydrin, or by advancing a mixture of a diglycidyl ether of the dihydric phenol and the dihydric phenol. While in any given molecule the value of m is an integer, the materials are invariably mixtures which can be characterized by an average value of m which is not necessarily a whole number. Polymeric materials with an average value of m between 0 and about 7 can be used in one aspect of the present disclosure. In other embodiments, the epoxy component may be a polyglycidyl amine from one or more of 2,2′-methylene dianiline, m-xylene dianiline, hydantoin, and isocyanate.

The epoxy component may be a cycloaliphatic (alicyclic) epoxide. Examples of suitable cycloaliphatic epoxides include diepoxides of cycloaliphatic esters of dicarboxylic acids, such as bis(3,4-epoxycyclohexylmethyl)oxalate, bis(3,4-epoxycyclohexylmethyl)adipate, bis(3,4-epoxy-6-methylcyclohexylmethyl)adipate, vinylcyclohexene diepoxides; limonene diepoxide; bis(3,4-epoxycyclohexylmethyl)pimelate; dicyclopentadiene diepoxide; and other suitable cycloaliphatic epoxides. Other suitable diepoxides of cycloaliphatic esters of dicarboxylic acids are described, for example, in WO 2009/089145 A1, which is hereby incorporated by reference.

Other cycloaliphatic epoxides include 3,3-epoxycyclohexylmethyl-3,4-epoxycyclohexane carboxylate such as 3,4-epoxycyclohexylmethyl-3,4-epoxycyclohexane carboxylate; 3,3-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexyl-methyl-3,4-epoxy-3-methylcyclohexane carboxylate. Other suitable 3,4-epoxycyclohexylmentyl-3,4-epoxycyclohexane carboxylates are described, for example, in U.S. Pat. No. 2,890,194, which is hereby incorporated by reference. In other embodiments, the epoxy component may include polyol polyglycidyl ether from polyethylene glycol, polypropylene glycol or polytetrahydrofuran, or combinations thereof.

Another aspect, according to the present disclosure, provides a method for preparing a cured epoxy resin product comprising:
(a) providing an epoxy curing agent comprising:
   (i) a contact product of an imidiazole compound and carboxlic acid, according to the present disclosure, and
   (ii) an anhydride curing agent;
   (b) contacting the epoxy curing agent formulation with at least one epoxy resin;
   (c) heating the composition to a curing temperature.

Epoxy compositions prepared from imidazole salt additives, anhydride curing agent and epoxy resin can be formulated with a wide variety of ingredients well known to those skilled in the art of coating formulation, including solvents, fillers, pigments, pigment dispersing agents, rheology modifiers, thixotropes, flow and leveling aids, defoamers, etc. Suitable additives for inclusion into the epoxy composition include, but are not limited to, fiberglass or quartz sand.

One component of epoxy compositions of this disclosure may be applied as coatings by any number of techniques including spray, brush, roller, paint mitt, and the like. Numerous substrates are suitable for application of coatings of this disclosure with proper surface preparation, as is well understood in the art. Such substrates include, but are not limited to, many types of metal, particularly steel and aluminum, as well as concrete.

Cured epoxy resin components, according to the present disclosure, may include components and products in a wide range of applications including, but not limited to, electrical insulating materials, molded articles, fiber reinforced composites, and filled castings, among other uses.

One component of epoxy coating compositions of this disclosure can be applied and cured at elevated temperatures ranging from greater than about 50° C., or about 50 to about 200° C., about 100 to about 180° C. or about 100 to about 150° C.

The disclosure is further illustrated by the following examples, which are not to be construed as imposing limitations to the scope of this disclosure. Various other aspects, embodiments, modifications, and equivalents thereof which, after reading the description herein, may suggest themselves to one of ordinary skill in the art without departing from the spirit of the present disclosure or the scope of the appended claims.

### EXAMPLES

### Example 1

### General Procedure for Preparation of Imidazole Salts:

(a) 1-Methylimidazole (1 mole was charged into a 3-neck round bottom flask equipped with a magnetic stirrer and nitrogen inlet and thermocouple. Acetic acid (1 mole) was added slowly to maintain the temperature at 25-35° C. On completion of the addition, the mixture was cooled to room temperature and used for DSC, working time, compatibility and elevated temperature reactivity studies.
(b) 1-Methylimidazole (1 mole) was charged into a 3-neck round bottom flask equipped with a magnetic stirrer and nitrogen inlet and thermocouple. Octanoic acid (1 mole) was added slowly to maintain the temperature at 25-35° C. On completion of the addition, the mixture was cooled to room temperature and used for DSC, working time, compatibility and elevated temperature reactivity studies.
(c) 1-Methylimidazole (1 mole) was charged into a 3-neck round bottom flask equipped with a magnetic stirrer and nitrogen inlet and thermocouple. Tall oil fatty acid (1 mole) was added slowly to maintain the temperature at 25-35° C. On completion of the addition, the mixture was cooled to room temperature and used for DSC, working time, compatibility and elevated temperature reactivity studies.
(d) 2-Ethyl-4-methylimidazole (1 mole) was charged into a 3-neck round bottom flask equipped with a magnetic stirrer and nitrogen inlet and thermocouple. Acetic acid (1 mole)) was added slowly to maintain the temperature at 25-35° C. On completion of the addition, the mixture was cooled to room temperature and used for DSC, working time, compatibility and elevated temperature reactivity studies.
(e) 2-Ethyl-4-methylimidazole (1 mole) was charged into a 3-neck round bottom flask equipped with a magnetic stirrer and nitrogen inlet and thermocouple. Octanoic acid (1 mole) was added slowly to maintain the temperature at 25-35° C. On completion of the addition, the mixture was cooled to room temperature and used for DSC, working time, compatibility and elevated temperature reactivity studies.
(f) 2-Ethyl-4-methylimidazole (1 mole) was charged into a 3-neck round bottom flask equipped with a magnetic stirrer and nitrogen inlet and thermocouple. Tall oil fatty acid (1 mole) was added slowly to maintain the temperature at 25-35° C. On completion of the addition, the mixture was cooled to room temperature and used for DSC, working time, compatibility and elevated temperature reactivity studies.
(g) 2-Imidazolyl-1-yl-succinic acid ethyl ester (1 mole) was charged into a 3-neck round bottom flask equipped with a magnetic stirrer and nitrogen inlet and thermocouple. Acetic acid (1 mole) was added slowly to maintain the temperature at 25-35° C. On completion of the addition, the mixture was cooled to room temperature and used for DSC, working time, compatibility and elevated temperature reactivity studies.
(h) 2-Imidazolyl-1-yl-succinic acid ethyl ester-4 (1 mole) was charged into a 3-neck round bottom flask equipped with a magnetic stirrer and nitrogen inlet and thermocouple. Octanoic acid (1 mole) was added slowly to maintain the temperature at 25-35° C. On completion of the addition, the mixture was cooled to room temperature and used for DSC, working time, compatibility and elevated temperature reactivity studies.
(i) 2-Imidazolyl-1-yl-succinic acid ethyl ester(1 mole) was charged into a 3-neck round bottom flask equipped with a magnetic stirrer and nitrogen inlet and thermocouple. Tall oil fatty acid (1 mole) was added slowly to maintain the temperature at 25-35° C. On completion of the addition, the mixture was cooled to room temperature and used for DSC, working time, compatibility and elevated temperature reactivity studies.

### Example 2

### Differential Scanning Calorimetric (DSC) Study of Anhydride Accelerators.

Imidazole salts (0.4 g), prepared according to the procedure described in Example 1, were mixed with methyl tetrahydrophthalic anhydride (MTHPA; 8 g), methyl hexahydrophthalic anhydride (MHHPA; 8 g) or dodecyl succinic anhydride (DDSA; 13 g), and with bisphenol A diglycidyl ether (DGEBA; 10 g) or epoxidized linseed oil (ELO) resin (10 g), using a speedmixer until a uniform mixture was obtained. A sample of this mixture was analyzed by using a commercially available DSC (TA Instruments Q200) having a software program embedded in the DSC that started at −10° C. and heated at 10° C./minute up to 300° C., cooled and scanned a second time to 250° C. The first scan provided cure data including onset temperature, peak exotherm and heat of reaction (ΔHc), while the second scan provided the glass transition temperature (Tg). Results are presented in Table 1. Table 1 below illustrates the thermal behavior of the epoxy curing composition comprising a combination of an imidazole salt accelerator, anhydride curing agent and epoxy resin. In particular, Table 1 illustrates:
(a) The imidazole salts having the formula according to Structure 1 functions as active accelerators for anhydrides in epoxy systems with ΔHc>120 J/g; and,
(b) The carboxylic acid used to prepare the inventive imidazole salts are generally inactive as anhydride accelerators as indicated by the negligible heat of reaction when used for curing the anhydride system.

TABLE 1
Results of DSC analysis using anhydride accelerators

| | | | | Onset | | |
|---|---|---|---|---|---|---|
| | | | Epoxy | temperature | ΔHc | T_{g} |
| Exp | Anhydride accelerator | Anhydride | resin | (° C.) | (J/g) | (° C.) |
| 145F | 1-methylimidazole | MTHPA | DGEBA | 109 | 343 | 112 |
| Ref | | | | | | |
| 145G | 1-methylimidazole salt | MTHPA | DGEBA | 114 | 347 | 117 |
| | with acetic acid | | | | | |
| 145H | 1-methylimidazole salt | MTHPA | DGEBA | 117 | 354 | 124 |
| | with octanoic acid | | | | | |
| 145I | 1-methylimidazole salt | MTHPA | DGEBA | 121 | 553 | 128 |
| | with tall oil fatty acid | | | | | |
| 156F | 2-ethyl-4- | DDSA | DGEBA | 122 | 273 | 73 |
| Ref | methylimidazole | | | | | |
| 156I | 2-ethyl-4- | DDSA | DGEBA | 126 | 270 | 61 |
| | methylimidazole with | | | | | |
| | acetic acid | | | | | |
| 156J | 2-ethyl-4- | DDSA | DGEBA | 133 | 257 | 77 |
| | methylimidazole with | | | | | |
| | tall oil fatty acid | | | | | |
| 145A | 1-methylimidazole | MTHPA | ELO | 137 | 355 | 53 |
| Ref | | | | | | |
| 145B | 1-methylimidazole salt | MTHPA | ELO | 140 | 353 | 53 |
| | with acetic acid | | | | | |
| 145C | 1-methylimidazole salt | MTHPA | ELO | 147 | 336 | 55 |
| | with octanoic acid | | | | | |
| 145D | 1-methylimidazole salt | MTHPA | ELO | 153 | 341 | 54 |
| | with tall oil fatty acid | | | | | |
| 156P | 1-methylimidazole | DDSA | DGEBA | 106 | 253 | 55 |
| Ref | | | | | | |
| 156Q | 1-methylimidazole salt | DDSA | DGEBA | 110 | 203 | 46 |
| | with acetic acid (1:2) | | | | | |
| 156R | 1-methylimidazole salt | DDSA | DGEBA | 121 | 245 | 55 |
| | with octanoic acid (1:2) | | | | | |
| 167B | 2-imidazol-1-yl-succinic | MHHPA | DGEBA | 124 | 335 | 140 |
| Ref | acid ethyl ester | | | | | |
| 167C | 2-imidazol-1-yl-succinic | MHHPA | DGEBA | 130 | 335 | 140 |
| | acid ethyl ester with | | | | | |
| | octanoic acid | | | | | |
| 167D | 2-imidazol-1-yl-succinic | MHHPA | DGEBA | 135 | 332 | 135 |
| | acid ethyl ester with tall | | | | | |
| | oil fatty acid | | | | | |
| 156M | Acetic acid | — | DGEBA | * | 0 | no |
| Ref | | | | | | |
| 156N | Octanoic acid | — | DGEBA | ** | <10 | no |
| Ref | | | | | | |
| 156O | Tall oil fatty acid | — | DGEBA | ** | <20 | no |
| Ref | | | | | | |

* no or ** no siginificant peak detected up to 250° C.

Table 1 above illustrates the thermal behavior of the epoxy curing composition comprising a combination of an imidazole salt accelerator, anhydride curing agent and epoxy resin. In particular, Table 1 illustrates:
(c) The imidazole salts having the formula according to Structure 1 function as active accelerators for anhydrides in epoxy systems with ΔHc>120 J/g; and,
(d) The carboxylic acid used to prepare the inventive imidazole salts are generally inactive as anhydride accelerators as indicated by the negligible heat of reaction when used for curing the anhydride system.

### Example 3

### Working Time Study of Anhydride Accelerators.

Several imidazole salts, prepared following the procedure described in Example 1, were analyzed for working time (latency). The imidazole salt (4 g) prepared was mixed with MTHPA (80 g), MHHPA (80 g) or DDSA (130 g), and with DGEBA (100 g) or ELO resin (100 g) using a stainless steel spatula until a uniform mixture was obtained. Working time of each system at 25° C. was measured by Brookfield viscometer. The viscosity versus time was recorded and the time to 10 and to 100 Pa.s was used as a measure for working time. Results are presented in Table 2.

TABLE 2
Results of working time analysis using anhydride accelerators

| | | | | Working time at | |
|---|---|---|---|---|---|
| | | | | 25° C. (days), i.e. | |
| | | | | time for viscosity | |
| | | | Epoxy | to reach | |
| Exp | Anhydride accelerator | Anhydride | resin | 10 Pa · s | 100 Pa · s |
| 145F Ref | 1-methylimidazole | MTHPA | DGEBA | 0.4 | 0.8 |
| 145G | 1-methylimidazole salt | MTHPA | DGEBA | 0.8 | 1.5 |
| | with acetic acid | | | | |
| 145H | 1-methylimidazole salt | MTHPA | DGEBA | 1.1 | 2.4 |
| | with octanoic acid | | | | |
| 145I | 1-methylimidazole salt | MTHPA | DGEBA | 1.8 | 3.3 |
| | with tall oil fatty acid | | | | |
| 156F Ref | 2-ethyl-4-methylimidazole | DDSA | DGEBA | 0.5 | 1.3 |
| 156I | 2-ethyl-4-methylimidazole | DDSA | DGEBA | 1.6 | 4.1 |
| | with acetic acid | | | | |
| 156J | 2-ethyl-4-methylimidazole | DDSA | DGEBA | 3.4 | 8.1 |
| | with tall oil fatty acid | | | | |
| 145A | 1-methylimidazole | MTHPA | ELO | 10 | 16 |
| Ref | | | | | |
| 145B | 1-methylimidazole salt | MTHPA | ELO | 14 | 22 |
| | with acetic acid | | | | |
| 145C | 1-methylimidazole salt | MTHPA | ELO | 21 | 30 |
| | with octanoic acid | | | | |
| 145D | 1-methylimidazole salt | MTHPA | ELO | 28 | 37 |
| | with tall oil fatty acid | | | | |
| 156P | 1-methylimidazole | DDSA | DGEBA | 0.3 | 0.8 |
| Ref | | | | | |
| 156Q | 1-methylimidazole salt | DDSA | DGEBA | 0.7 | 1.6 |
| | with acetic acid (1:2) | | | | |
| 156R | 1-methylimidazole with | DDSA | DGEBA | 1.6 | 3.6 |
| | octanoic acid (1:2) | | | | |
| 167B | 2-imidazol-1-yl-succinic | MHHPA | DGEBA | 0.7 | 1.6 |
| Ref | acid ethyl ester | | | | |
| 167C | 2-imidazol-1-yl-succinic | MHHPA | DGEBA | 1.9 | 3.7 |
| | acid ethyl ester salt with | | | | |
| | octanoic acid noic acid | | | | |
| 167D | 2-imidazol-1-yl-succinic | MHHPA | DGEBA | 3.1 | 6.1 |
| | acid ethyl ester with tall oil | | | | |
| | fatty acid | | | | |

Table 2 above compares the latency of the imidazole salts, according to the present disclosure, with comparative imidazoles. In particular, Table 2 illustrates: 1

(a) The inventive imidazole salts provided 2-7 times longer working time with DGEBA resin as the conventional imidazole curing agent;
(b) The inventive imidazole salts provided 2-3 times longer working time with ELO resin as the conventional imidazole curing agent

### Example 4

### Compatibility of Curing Agent Compositions.

A blend of DDSA and MTHPA was prepared in a 80:20 weight ratio by mixing in a 500 ml beaker at 50° C. Imidazole salts (0.4 g), prepared according to Example 1, were mixed with this anhydride blend (8 g) using a stainless steel spatula until a uniform mixture was obtained. The anhydride/accelerator blends (formulations 3-1 to 3-7 shown in Table 3) were next analyzed on visual appearance.

TABLE 3
Results of compatibility analysis using anhydride accelerators

| | | | Accelerator |
|---|---|---|---|
| | | | compatibility |
| | Accelerator | | with |
| Exp | Trade Name | Chemical name | anhydride |
| 3-1 | Imicure AMI-1 | 1-methylimidazole | Yes |
| Ref | | | |
| 3-2 | Experimental | 1-methylimidazole with acetic acid | Yes |
| 3-3 | Experimental | 1-methylimidazole with octanoic | Yes |
| | | acid | |
| 3-4 | Experimental | 1-methylimidazole with TOFA | Yes |
| 3-5 | Imicure | 2-ethyl-4-methylimidazole | Yes |
| Ref | EMI-24 | | |
| 3-6 | Experimental | 2-ethyl-4-methylimidazole with | Yes |
| | | acetic acid | |
| 3-7 | Experimental | 2-ethyl-4-methylimidazole with | Yes |
| | | TOFA | |

Table 3 above illustrates that the inventive imidazole salts have a good compatibility with anhydride curing agents.

In Table 3, DDSA and MTHPA were used as an anhydride mixture and mixed with various accelerators, which were added to determine their solubility. It is desirable to use formulated curing agents in a liquid form for structural composite applications to avoid the filtration of an accelerator during processing. The solubility of all liquid accelerators was good in the anhydride blend, which implies that these liquid accelerators will have good compatibility with anhydride curing agents.

### Example 5

### Elevated Temperature Reactivity of Anhydride Accelerators.

Several anhydride curing agent formulations were prepared. MTHPA, MHHPA or DDSA was used as the curing agent and Imicure AMI-1 (1-methylimidazole), Imicure EMI-24 (2-ethyl-4-methylimidazole) or 2-imidazol-1-yl-succinic acid ethyl ester as utilized as an accelerator curing agent (reference). Imidazole salts (0.4 g), prepared according to the procedure described in Example 1, were mixed with MTHPA (8 g) or DDSA (13 g), and with DGEBA (10 g) or ELO resin (10 g) using a speedmixer until a uniform mixture was obtained. Products were mixed as shown in Table 4. Formulations 145F, 156F, 145A and 156P are comparative examples wherein formulation 145F is liquid DGEBA resin with MTHPA and Imicure® AMI-1, formulation 156F is liquid DGEBA resin with DDSA and Imicure® EMI-14, formulation 145A is ELO resin with MTHPA and Imicure® AMI-1, and formulation 156P is liquid DGEBA resin with DDSA and Imicure® AMI-1. Imicure®AMI-1 is a registered trademark of Air Products & Chemicals. DGEBA resin used for this work is EPON® 828 (Hexion) and ELO resin used is Lankroflex L (Akcros). Formulations 145G, H, I, 156 I, J, 145B, C, D, 156Q and R are based on the accelerator compositions covered by the present disclosure.

The elevated temperature reactivity of all formulations shown in Example 5 was determined at 125° C. by measuring the gel point (G′=G″) using an Anton Paar MCR 302 Rheometer.

TABLE 4
Results of elevated temperature reactivity
analysis using anhydride accelerators

| | | | | Time to |
|---|---|---|---|---|
| | | | | gel point |
| | | | | {G′ = G″} |
| | | | | at 125° C. |
| Exp | Anhydride accelerator | Anhydride | Epoxy resin | (min) |
| 145F | 1-methylimidazole | MTHPA | DGEBA | 8 |
| Ref | | | | |
| 145G | 1-methylimidazole salt with | MTHPA | DGEBA | 9 |
| | acetic acid | | | |
| 145H | 1-methylimidazole salt with | MTHPA | DGEBA | 12 |
| | octanoic acid | | | |
| 145I | 1-methylimidazole salt with | MTHPA | DGEBA | 17 |
| | tall oil fatty acid | | | |
| 156F | 2-ethyl-4-methylimidazole | DDSA | DGEBA | 10 |
| Ref | | | | |
| 156I | 2-ethyl-4-methylimidazole | DDSA | DGEBA | 13 |
| | with acetic acid | | | |
| 156J | 2-ethyl-4-methylimidazole | DDSA | DGEBA | 24 |
| | with tall oil fatty acid | | | |
| 145A | 1-methylimidazole | MTHPA | ELO | 34 |
| Ref | | | | |
| 145B | 1-methylimidazole salt with | MTHPA | ELO | 47 |
| | acetic acid | | | |
| 145C | 1-methylimidazole salt with | MTHPA | ELO | 46 |
| | octanoic acid | | | |
| 145D | 1-methylimidazole salt with | MTHPA | ELO | 65 |
| | tall oil fatty acid | | | |
| 156P | 1-methylimidazole | DDSA | DGEBA | 10 |
| Ref | | | | |
| 156Q | 1-methylimidazole salt with | DDSA | DGEBA | 14 |
| | acetic acid (1:2) | | | |
| 156R | 1-methylimidazole salt with | DDSA | DGEBA | 25 |
| | octanoic acid (1:2) | | | |
| 167B | 2-imidazol-1-yl-succinic | MHHPA | DGEBA | 14 |
| Ref | acid ethyl ester | | | |
| 167C | 2-imidazol-1-yl-succinic | MHHPA | DGEBA | 26 |
| | acid ethyl ester with | | | |
| | octanoic acid | | | |
| 167D | 2-imidazol-1-yl-succinic | MHHPA | DGEBA | 32 |
| | acid ethyl ester | | | |

Table 4 above compares the elevated temperature reactivity of the inventive imidazole salts with imidazoles. In particular, Table 4 illustrates:
(a) The inventive imidazole salts provided an only 1-2 times longer time to gel point with DGEBA resin as the conventional curing agent;
(b) The inventive imidazole salts provided an only 1-2 times longer time to gel point with ELO resin as the conventional curing agent.

Overall the inventive imidazole salts provided significantly longer working times with epoxy resins and still providing sufficient elevated temperature reactivity.

While the invention has been described with reference to certain aspects or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A curing agent composition comprising at least one imidazole salt represented by the structure: 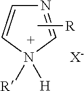
wherein R, R′, is H, or alkyl (1-20 carbon atoms) preferably lower alkyl of 1-7 carbon atoms, haloalkyl (1-20 carbon atoms), aryl, hydroxyl alkyl (1-7 carbon atoms), ester group(s), substituted alkyl and X⁻ is a carboxylate anion of 1-40 carbon atoms; and
at least one anhydride curing agent.

2. The curing agent composition of claim 1, wherein the imidazole salt comprises the contact product of at least one carboxylic acid compound and at least one imidazole compound.

3. The curing agent composition of claim 2, wherein the imidazole compound is selected from the group consisting of 1-methylimidazole, 2-methylimidazole, 2-ethyl-4-methylimidazole, 2-imidazol-1-yl-succinic acid ethyl ester,1-cyanoethyl-2-undecylimidazolium trimellitate and the epoxy-imidazole adduct thereof, and combinations thereof.

4. The curing agent composition of claim 2, wherein the carboxylic acid compound comprises at least one compound selected from the group consisting of acetic acid, propanoic acid, hexanoic acid, 2-ethylhexanoic acid, octanoic acid, nonanoic acid, decanoic acid, tall oil fatty acid (TOFA), dimer acid, and combinations thereof.

5. The curing agent composition of claim 4, wherein the carboxylic acid is selected from the group consisting of acetic acid, octanoic acid and tall oil fatty acid.

6. The curing agent composition of claim 1, wherein the anhydride curing agent comprises at least one member selected from the group consisting of polysebacic and polyazelaic anhydride; methyltetrahydrophthalic anhydride, tetrahydro phthalic anhydride, methyl nadic anhydride, hexahydro phthalicanhydride, and methylhexahydro phthalic anhydride; succinic anhydride, substituted succinic anhydride, citric acid anhydride, maleic anhydride, adducts of maleic anhydride, dodecyl succinic anhydride, maleic anhydride vinyl and styrene copolymers of maleic anhydride, multi-ring alicyclic anhydrides, phthalic anhydride, trimellitic anhydride, and combinations thereof.

7. An epoxy composition comprising the epoxy curing agent composition of claim 1 and at least one epoxy resin.

8. The epoxy composition of claim 7 further comprising an additive.

9. The epoxy composition of claim 7, wherein the epoxy composition has an onset temperature ranging from about 50 to about 200° C.; an ΔHc of about 150 to about 400 J/g, and a Tg ranging from about 40 to about 175° C.

10. The epoxy composition of claim 9, wherein the composition is substantially free of water.

11. A cured epoxy product comprising the contact product of the epoxy curing agent composition of claim 1 and at least one epoxy resin.

12. The method of forming a cured epoxy product, the method comprising:
(a) providing an epoxy curing agent comprising:
at least one imidazole salt represented by the structure: 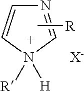
R, R″ is H, or alkyl (1-20 carbon atoms) preferably lower alkyl of 1-7 carbon atoms, haloalkyl (1-20 carbon atoms), aryl, hydroxyl alkyl (1-7 carbon atoms), ester group(s) substituted alkyl and X− is a carboxylate anion of 1-40 carbon atoms, and
an anhydride curing agent;
(b) contacting the epoxy curing agent composition with at least one epoxy resin; and
(c) heating the composition to a curing temperature to form the cured epoxy product.

13. The method of claim 12, wherein the curing temperature is a temperature of at least 50° C.
